(19) United States
(12) Patent Application Publication
(10) Pub. No.: US 2023/0253553 A1
(43) Pub. Date: Aug. 10, 2023

(54) NEGATIVE ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Won-Gi AHN, Yongin-si (KR); Min-young JEONG, Yongin-si (KR); Taeil LEE, Yongin-si (KR); Juhye BAE, Yongin-si (KR); Gwangwon PARK, Yongin-si (KR)

(21) Appl. No.: 18/165,782

(22) Filed: Feb. 7, 2023

(30) Foreign Application Priority Data
Feb. 7, 2022 (KR) 10-2022-0015774

(51) Int. Cl. H01M 4/36; H01M 4/133; H01M 4/134; H01M 4/587; H01M 4/38; H01M 10/0525; H01M 4/04; H01M 4/1393; H01M 4/1395

(52) U.S. Cl. CPC H01M 4/366; H01M 4/133; H01M 4/134; H01M 4/587; H01M 4/364; H01M 4/386; H01M 10/0525; H01M 4/0404; H01M 4/1393; H01M 4/1395; H01M 2004/027

(57) ABSTRACT

A negative electrode for a rechargeable lithium battery and a rechargeable lithium battery including the same are provided. The negative electrode includes a current collector and a negative active material layer including a first active material layer, a second active material layer, and a third active material layer, wherein the first active material layer contacts the current collector and the second active material layer is between the first active material layer and the third active material layer, wherein the first active material layer includes a first active material including a first crystalline carbon, the second active material layer includes a second active material including a silicon-based active material, a second crystalline carbon and a third crystalline carbon, and third active material layer includes a third active material including a fourth crystalline carbon.

### CROSS-REFERENCE TO RELATED APPLICATION

This application claims priority to and the benefit of Korean Patent Application No. 10-2022-0015774, filed in the Korean Intellectual Property Office on Feb. 7, 2022, the entire content of which is hereby incorporated by reference.

### BACKGROUND

### 1. Field

Embodiments of the present disclosure relate to a negative electrode for a rechargeable lithium battery and a rechargeable lithium battery including the same.

### 2. Description of the Related Art

Recently, the rapid spread of electronic devices such as mobile phones, laptop computers, and electric vehicles, which utilize or require batteries, has resulted in surprising increases in demands for rechargeable batteries with relatively high capacity and lighter weight. For example, rechargeable lithium batteries have recently drawn attention for use as driving power sources for portable devices, as they have relatively lighter weights and higher energy densities. Accordingly, research into improving the performance of rechargeable lithium batteries is being actively undertaken.

A rechargeable lithium battery includes a positive electrode and a negative electrode, which may include an active material being capable of intercalating and deintercalating lithium ions, and an electrolyte, and the rechargeable lithium battery may generate electrical energy due to oxidation and reduction reactions that occur when lithium ions are intercalated and deintercalated into the positive electrode and the negative electrode.

For positive active materials of rechargeable lithium batteries, transition metal compounds such as lithium cobalt oxides, lithium nickel oxides, and/or lithium manganese oxide are mainly utilized. For the negative active materials, a carbonaceous material such as a crystalline carbon material (such as natural graphite and/or artificial graphite) and/or an amorphous carbonaceous material and/or a silicon-based material may be utilized.

Recently, there have been attempts to thickly prepare a negative active material layer by utilizing a carbonaceous material, especially, by mixing crystalline carbon with a silicon-carbon active material in order to improve a current density of the rechargeable lithium battery. However, it causes the deterioration and expansion of the negative electrode to occur during charging and discharging, thereby fading cycle-life characteristics and deteriorating performance.

The above information disclosed in this Background section is only for enhancement of understanding of the background of the present disclosure, and therefore it may contain information that does not form the prior art that is already known in this country to a person of ordinary skill in the art.

### SUMMARY

Aspects of one or more embodiments of the present disclosure are directed towards a negative electrode for a rechargeable lithium battery exhibiting excellent or suitable cycle-life characteristics and high capability characteristics.

Aspects of one or more embodiments of the present disclosure are directed towards a rechargeable lithium battery including the negative electrode.

Additional aspects will be set forth in part in the description which follows and, in part, will be apparent from the description, or may be learned by practice of the presented embodiments of the disclosure.

One or more embodiments of the present disclosure provides a negative electrode for a rechargeable lithium battery, the negative electrode including a current collector; and a negative active material layer including a first active material layer, a second active material layer, and a third active material layer, wherein the first active material layer contacts the current collector and the second active material layer is between the first active material layer and the third active material layer, the first active material layer includes a first active material including (e.g., composed or formed of) a first crystalline carbon, the second active material layer includes a second active material including (e.g., composed or formed of) a silicon-based active material, a second crystalline carbon and a third crystalline carbon, and the third active material layer includes a third active material including (e.g., composed or formed of) a fourth crystalline carbon.

In one or more embodiments, an amount of silicon in the negative active material layer may be about 0.6 wt % to about 9 wt % based on a total, 100 wt % of the negative active material layer.

In one or more embodiments, a thickness ratio of the first active material layer, the second active material layer, and the third active material layer may be about 1:1 to 49:1 to 49. In one or more embodiments, a thickness ratio of the first active material layer, the second active material layer, and the third active material layer may be about 1:1 to 1.5:1 to 1.5.

In one or more embodiments, the first crystalline carbon or the second crystalline carbon may include a natural graphite including secondary particles including a plurality of primary particles that are agglomerated, amorphous carbon on a surface of the plurality of primary particles, and a coating layer including amorphous carbon around (e.g., surrounding) the secondary particles.

In one or more embodiments, the plurality of primary particles may have a particle diameter (e.g., an average particle diameter) of about 5 μm to about 15 μm, and the secondary particles may have a particle diameter (e.g. an average particle diameter) of about 8 μm to about 24 μm, and a peak intensity ratio I(002)/I(110) may be about 120 or less, when measured by XRD (x-ray diffraction or x-ray powder diffraction).

In one or more embodiments, a mixing ratio of the second crystalline carbon and the third crystalline carbon may be about 1:1 to about 1:9 by weight ratio.

In one or more embodiments, the third crystalline carbon may be artificial graphite.

In one or more embodiments, the fourth crystalline carbon may be artificial graphite, natural graphite, or a combination thereof.

One or more embodiments of the present disclosure provides a rechargeable lithium battery including the negative electrode; a positive electrode, and an electrolyte.

One or more embodiments of the present disclosure provides a method of manufacturing a negative electrode for a rechargeable lithium battery, the negative electrode including a current collector and a negative active material layer including a first active material layer of a first active material, a second active material layer of a second active material, and a third active material layer of a third active material, the method including: applying the current collector; applying the first active material of the first active material layer to contact the current collector, the first active material including a first crystalline carbon; applying the second active material of the second active material layer, the second active material including a silicon-based active material, a second crystalline carbon, and a third crystalline carbon; and applying the third active material of the third active material layer such that the second active material layer is between the first active material layer and the third active material layer, the third active material including a fourth crystalline carbon.

The negative active material according to aspects of one or more embodiments may exhibit excellent or suitable cycle-life characteristics and high capability characteristics.

### BRIEF DESCRIPTION OF THE DRAWINGS

FIG. 1 is a schematic view of a structure of a negative electrode for a rechargeable lithium battery according to one or more embodiments of the present disclosure.

FIG. 2 is a schematic perspective view of a rechargeable lithium battery according to one or more embodiments of the present disclosure.

FIG. 3 is a graph showing the room temperature cycle-life characteristics of the rechargeable lithium cells according to Examples 1 and 2 and Comparative Examples 1 and 2.

### DETAILED DESCRIPTION

The present disclosure may be modified in many alternate forms, and thus specific embodiments will be illustrated in the drawings and described in more detail herein. It should be understood, however, that the drawings and detailed description are not intended to limit the present disclosure to the particular forms disclosed, but rather, they are intended to cover all modifications, equivalents, and alternatives falling within the spirit and scope of the present disclosure.

In the present disclosure, when particles are spherical, “diameter” indicates a particle diameter or an average particle diameter, and when the particles are non-spherical, the “diameter” indicates a major axis length or an average major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

The average particle diameter or size (D50) may be measured by a method well generally available to those skilled in the art, for example, by a particle size analyzer, or also by a transmission electron microscopic image or a scanning electron microscopic image. In some embodiments, a dynamic light-scattering measurement device is utilized to perform a data analysis, and the number of particles is counted for each particle size range. From this, the average particle diameter or size (D50) value may be easily obtained through a calculation.

A negative electrode for a rechargeable lithium battery according to one or more embodiments includes a current collector and a negative active material layer positioned on the current collector.

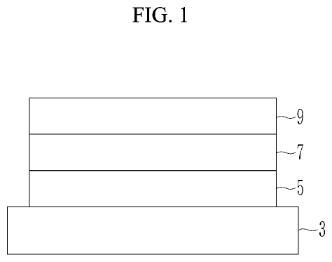

The negative active material layer includes a first active material layer, a second active material layer, and a third active material layer. Herein, the first active material layer is positioned in contact with the current collector, and the second active material layer is positioned between the first active material layer and the third active material layer. A structure of the negative electrode according to one or more embodiments will be illustrated in more detail, and based on FIG. 1, the negative electrode 1 of one or more embodiments includes the second negative active material layer 7 positioned between the first negative active material layer 5 and the third negative active material layer 9. For example, the second negative active material layer 7 is included as a middle layer in the negative electrode, the first negative active material layer 5 is included in the negative electrode in order to directly contact the current collector 3, and the third negative active material layer 9 is positioned on a surface.

The first negative active material layer includes a first crystalline carbon as a first active material. The second negative active material layer includes a silicon-based active material, a second crystalline carbon, and a third crystalline carbon, as a second active material. The third active material layer includes a fourth crystalline carbon, as a third active material.

As such, the negative electrode according to one or more embodiments includes the silicon-based active material in the second active material layer which is a middle layer, and silicon is only included in the second active material layer, and is not included in the first active material layer and the third active material layer.

Here, in one or more embodiments, only inclusion of silicon included in the second active material layer may aid in decreasing the expansion of silicon during charging and discharging and decreasing depletion of an electrolyte, so that the cycle-life characteristics may be improved and the high capability characteristics may be improved.

As the first active material layer includes the first crystalline carbon as the first active material and the third active material layer includes the fourth crystalline carbon as the third active material, the adherence of the electrode may be improved, thereby readily transferring electrons and strengthening intercalating and deintercalating of lithium ions, so that it may more effectively improve high capability than amorphous carbon.

When silicon is included in the first active material layer, deformation of the current collector due to the expansion of silicon may occur. When silicon is included in the third active material layer, deterioration in the cycle-life characteristics and high capability due to the expansion of silicon may occur.

In one or more embodiments, an amount of silicon may be about 0.6 wt % to about 9 wt %, about 2.5 wt % to about 8 wt %, or about 1.8 wt % to about 4.8 wt % based on the total, 100 wt % of the negative active material layer. This indicates about 0.6 wt % to about 9 wt % based on the total, 100 wt %, when the total amount of the first active material layer, the second active material layer, and the third active material layer is considered as 100 wt %. Furthermore, the amount of the silicon refers to an amount of silicon in the silicon-based active material. When the amount of silicon is within the aforementioned ranges, the cycle-life characteristics may be further improved.

An amount of silicon included in the second active material layer may be about 1.8 wt % to about 27 wt %, or about 5.4 wt % to about 14.4 wt %, when the amount of the second active material layer is considered to as 100 wt %. Furthermore, the amount of the silicon refers to an amount included in the silicon-based active material. When the amount of the silicon is within the aforementioned ranges, the expansion of silicon may be further effectively suppressed or reduced.

In one or more embodiments, a thickness ratio of the first active material layer, the second active material layer, and the third active material layer may be about 1:1 to 49:1 to 49, and a thickness ratio of the first active material layer, the second active material layer, and the third active material layer may be about 1:1 to 1.5:1 to 1.5. When the thickness ratio of the first active material layer, the second active material layer, and the third active material layer is within the aforementioned ranges, three layers may be uniformly (or substantially uniformly) formed, thereby maximizing or increasing effects for preventing or reducing the volume expansion of silicon.

The first active material included in the first active material layer may be a first crystalline carbon, and the first crystalline carbon may be natural graphite showing similar properties to artificial graphite, and including natural graphite in which a plurality of a primary particle are agglomerated, amorphous carbon positioned on a surface of the primary particles, and a coating layer including amorphous carbon around (e.g., surrounding) the secondary particle.

The primary particle may have a particle diameter of about 5 μm to about 15 μm, and the secondary particle may have a particle diameter of about 8 μm to about 24 μm. When the average particle diameter of the primary particle is within the aforementioned ranges, it may be suitably prepared and better cycle-life characteristics may be exhibited. When the particle diameter of the secondary particle is in the aforementioned ranges, the impregnation of the electrolyte may suitably occur. Furthermore, when the particle diameters of the primary particle and the secondary particle are within the aforementioned ranges, the expansion of the negative active material may be more effectively suppressed or reduced, and a tap density of the negative active material may be increased.

The primary particle may have a particle diameter of about 5 μm to about 15 μm, for example, about 5 μm to about 13 μm, about 5 μm to about 12 μm, or about 5.5 μm to about 11.5 μm, and the secondary particle may have a particle diameter of about 8 μm to about 24 μm, for example, about 10 μm to about 24 μm, about 11 μm to about 24 μm, about 12 μm to about 24 μm, about 13 μm to about 24 μm, about 13 μm to about 23 μm, or about 13 μm to about 20 μm. The particle diameters of the primary particle(s) and the secondary particle(s) may each refer to an average particle diameter (or size).

As utilized herein, an average particle diameter refers to a particle diameter (D50) where a cumulative volume is about 50 volume % in a particle distribution and measured by PSA (particle size analyzer) to which a plurality of particles are added.

The secondary particle may be obtained from agglomerating a plurality of primary particles, the numbers of the primary particle are not particularly limited, as long as it is possible to prepare a secondary particle, but, for example, 2 primary particles to 50 primary particles, 2 primary particles to 40 primary particles, 2 primary particles to 30 primary particles, 2 primary particles to 20 primary particles, 2 primary particles to 10 primary particles, or 2 primary particles to 4 primary particles may be agglomerated to prepare a secondary particle.

The natural graphite may be flaky-shaped (scale-type or kind, scale shaped, or flake shaped) natural graphite.

The first crystalline carbon includes a coating layer including amorphous carbon around (e.g., surrounding) the secondary particle and amorphous carbon positioned on the surface of the primary particle. The additional coatings of amorphous carbon to/on the surface of the primary particles (which are inside of the secondary particle) and to/on the secondary particle of natural graphite help to decrease a pore volume fraction and to suppress or reduce the side reaction with the electrolyte, so that charge and discharge capability may be further improved.

In the first crystalline carbon, a mixing ratio of natural graphite and amorphous carbon may be about 90:10 to about 75:25, for example, about 90:10 to about 80:20, about 90:10 to about 85:15, or about 90:10 to about 88:12 by weight ratio. In the case of the aforementioned ranges, the side reaction with the electrolyte may be further effectively suppressed or reduced, and the charge and discharge capability may be further improved.

The coating layer including amorphous carbon may have a thickness of about 5 nm to about 50 nm, for example, about 10 nm to about 50 nm, or about 20 nm to about 50 nm. When the thickness of the coating layer is within the aforementioned ranges, the side reaction with the electrolyte may be further suppressed or reduced and the charge and discharge rate capability may be further improved.

The amorphous carbon may be at least one of (e.g., one selected from) soft carbon, hard carbon, mesophase pitch carbide, sintered cokes, or a mixture thereof.

The first crystalline carbon of the first active material may be a peak intensity ratio I(002)/I(110) of about 120 or less, for example, about 110 or less, about 105 or less, or about 100 or less, measured by an X-ray diffraction analysis utilizing a CuKα-ray. The peak intensity ratio I(002)/I(110) refers to a ratio of the diffraction peak intensity I(002) to the diffraction peak intensity I(110) measured by an X-ray diffraction analysis of the first crystalline carbon and is an index relating to the orientation of the first active material layer of the first active material particle. As the peak intensity ratio I(002)/I(110) is smaller, the crystallite orientation of the first active material particle is random, and as the peak intensity ratio is increased, the crystallite is parallel to the first active material layer. For example, a smaller peak intensity causes the edges of natural graphite to randomly orient, thereby increasing non-orientation of the negative active material. Accordingly, lithium ions are easily intercalated/deintercalated to inside of the secondary particle of the natural graphite secondary particle, and thus capacity characteristics and charge and discharge rate capability characteristics of the rechargeable lithium battery may be further improved.

One or more embodiments employ natural graphite in which crystallite is isotropically grown and natural graphite primary particles are pulverized to have a small particle size and agglomerated to prepare a secondary particle, thereby more effectively suppressing or reducing increases in the orientation degree of the crystallite during the negative electrode preparation.

When the peak intensity ratio I(002)/I(110) is in the aforementioned ranges, the expansion ratio of the first active material is small which reduces internal pore volume and reduces side reactions with the electrolyte, thereby further improving the cycle-life characteristics.

The second active material in the second active material layer may be a silicon-based active material, a second crystalline carbon and a third crystalline carbon. The silicon-based active material, for example, may be a silicon-carbon composite. Herein, a mixing ratio of the silicon-based active material to the second crystalline carbon and third crystalline carbon may be about 1:15 weight ratio to about 3:8 by weight ratio. When the mixing ratio of the silicon-based active material to the second crystalline carbon and third crystalline carbon falls in the aforementioned ranges, the battery capacity may be further improved and the cycle-life characteristics may be further improved.

In the Si—C composite, carbon may be amorphous carbon or crystalline carbon. The composite may be an agglomerated product in which silicon and carbon are agglomerated, or an agglomerated product including a core in which silicon particles and crystalline carbon are mixed, and amorphous carbon is around (e.g., surrounding) the core. In one or more embodiments, the amorphous carbon may be filled in the core.

The amorphous carbon may be pitch carbon, soft carbon, hard carbon, mesophase pitch carbide, sintered cokes, carbon fiber, or a combination thereof, and the crystalline carbon may be artificial graphite, natural graphite, or a combination thereof.

The Si particles may have a particle diameter (e.g., an average particle diameter) of about 10 nm to about 30 μm, and according to one or more embodiments, of about 10 nm to about 1000 nm, or in some embodiments, of about 20 nm to about 150 nm. When the particle diameter (e.g., average particle diameter) of the Si particles is within the aforementioned ranges, the volume expansion caused during charge and discharge may be suppressed or reduced, and breakage of the conductive path due to crushing of particles may be prevented or reduced.

In the Si—C composite, an amount of Si may be about 30 wt % to about 70 wt %, and according to one or more embodiments, about 40 wt % to about 50 wt %. An amount of carbon may be about 70 wt % to about 30 wt %, or according to one or more embodiments, may be about 50 wt % to about 60 wt %. When the amounts of Si and carbon are within the aforementioned ranges, the high-capacity characteristic may be exhibited.

When the Si—C composite includes a core and amorphous carbon around (e.g., surrounding) the core, the amorphous carbon may be presented in a thickness of about 5 nm to about 100 nm. Herein, an amount of amorphous carbon may be about 1 wt % to about 50 wt % based on the total, 100 wt % of the Si—C composite, an amount of Si may be about 30 wt % to about 70 wt % based on the total, 100 wt % of the Si—C composite, and an amount of crystalline carbon may be about 20 wt % to about 69 wt % based on the total, 100 wt % of the Si—C composite. An amount of amorphous carbon may be the sum of the amount of amorphous carbon around (e.g., surrounding) the core and amorphous carbon filled in the core.

The second crystalline carbon may be the same or substantially the same as the aforementioned crystalline carbon, and the third crystalline carbon may be artificial graphite.

A mixing of the second crystalline carbon and the third crystalline carbon may be also about 1:1 to 1:9 by weight ratio. When the mixing ratio of the second crystalline carbon and the third crystalline carbon falls in the aforementioned range, high-rate characteristics may be further improved and the long cycle-life characteristic may be improved.

The third active material in the third active material layer may be a fourth crystalline carbon. The fourth crystalline carbon may be natural graphite, artificial graphite, or a combination thereof.

The first active material layer, the second active material layer, and the third active material layer may further include a binder, respectively, and a conductive material, respectively.

In the first active material layer, the second active material layer, and the third active material layer, an amount of each negative active material may be about 90 wt % to about 99 wt %, or about 94 wt % to about 99 wt % based on the total, 100 wt % of the active material layer.

Furthermore, in the first active material layer, the second active material layer, and the third active material layer, an amount of the binder in the first active material layer, the second active material layer, and the third active material layer may be about 0.5 wt % to about 5 wt %, or about 0.5 wt % to about 3 wt % based on the total, 100 wt % of each active material layer. In the first active material layer, the second active material layer, and the third active material layer, an amount of the conductive material may be about 0.5 wt % to about 5 wt %, or about 0.5 wt % to about 3 wt % based on the total, 100 wt % of each active material layer.

The binder improves binding properties of negative electrode active material particles with one another and with a current collector. The binder may be an aqueous binder, a non-aqueous binder, or a combination thereof.

The non-aqueous binder may be an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may be a styrene-butadiene rubber (SBR), an acrylated styrene-butadiene rubber (ABR), an acrylonitrile-butadiene rubber, an acryl rubber, a butyl rubber, a fluorine rubber, an ethylene oxide-containing polymer, polyvinylpyrrolidone, polypropylene, polyepichlorohydrin, polyphosphazene, ethylene propylene diene copolymer, polyvinylpyridine, chlorosulfonated polyethylene, latex, a polyester resin, an acryl resin, a phenol resin, an epoxy resin, polyvinyl alcohol, or a combination thereof.

When the binder uses the aqueous binder, a cellulose-based compound may be further utilized to provide viscosity as a thickener. The cellulose-based compound includes one or more of carboxymethyl cellulose, hydroxypropyl methyl cellulose, methyl cellulose, or alkali metal salts thereof. The alkali metal may be Na, K, or Li. The cellulose-based compound may be included in an amount of about 0.1 parts by weight to about 3 parts by weight based on 100 parts by weight of the negative active material.

The conductive material is included to provide electrode conductivity (e.g., is a conductor). Any electrically conductive material may be utilized as a conductive material unless it causes a chemical change. Examples of the conductive material may include a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; and/or a mixture thereof.

The current collector may include one of (e.g., one selected from) a copper foil, a nickel foil, a stainless steel foil, a titanium foil, a nickel foam, a copper foam, a polymer substrate coated with a conductive metal, and/or a combination thereof, but the present disclosure is not limited thereto.

One or more embodiments of the present disclosure provide a rechargeable lithium battery including the negative electrode, a positive electrode, and an electrolyte.

The positive electrode includes a current collector and a positive active material layer formed on the current collector. The positive active material may include lithiated intercalation compounds that reversibly intercalate and deintercalate lithium ions. For example, one or more composite oxides of a metal may include (e.g. may be selected from) cobalt, manganese, nickel, and/or a combination thereof, and lithium may be utilized. In one or more embodiments, the compounds represented by one or more of the following chemical formulae may be utilized: LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0≤e≤0.1); LiₐNi_{b}Co_{c}Al_{d}GₑO₂ (0.90≤a≤1.8, 0≤b≤0.9, 0≤c≤0.5, 0≤d≤0.5, 0≤e≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8).

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound including (e.g., selected from) an oxide of a coating element, a hydroxide of a coating element, an oxyhydroxide of a coating element, an oxycarbonate of a coating element, and/or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material utilizing these elements in the compound. For example, the method may include any coating method such as spray coating, dipping, and/or the like, but is not described in more detail because it is generally available in the related field.

In the positive electrode, an amount of the positive active material may be about 90 wt % to about 98 wt % based on the total weight of the positive active material layer.

In one or more embodiments, the positive active material layers may further include a binder and a conductive material. Herein, the amounts of the binder and the conductive material may be, respectively, about 1 wt % to about 5 wt % based on the total amount of the positive active material layer.

The binder improves binding properties of positive active material particles with one another and with a current collector. Examples thereof may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

The conductive material is included to provide electrode conductivity (e.g., is a conductor). Any electrically conductive material may be utilized as a conductive material unless it causes a chemical change. Examples of the conductive material may include a carbon-based material such as natural graphite, artificial graphite, carbon black, acetylene black, ketjen black, a carbon fiber and/or the like; a metal-based material of a metal powder or a metal fiber including copper, nickel, aluminum, silver, and/or the like; a conductive polymer such as a polyphenylene derivative; and/or a mixture thereof.

The current collector may be Al, but the present disclosure is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, caprolactone, and/or the like. The ether-based solvent may include dibutyl ether, tetraglyme, diglyme, dimethoxy ethane, 2-methyltetrahydrofuran, tetrahydrofuran, and/or the like. The ketone-based solvent may include cyclohexanone, and/or the like. The alcohol-based solvent may include ethyl alcohol, isopropyl alcohol, and/or the like, and examples of the aprotic solvent may include nitriles such as R—CN (where R is a C2 to C20 linear, branched, or cyclic hydrocarbon, or may include a double bond, an aromatic ring, or an ether bond), amides such as dimethylformamide, dioxolanes such as 1,3-dioxolane, sulfolanes, and/or the like.

The organic solvent may be utilized alone or in a mixture. When the organic solvent is utilized in a mixture, the mixture ratio may be controlled or selected in accordance with a desirable battery performance and it may be well understood to one of ordinary skill in the related art.

The carbonate-based solvent may include a mixture of a cyclic carbonate and a linear carbonate. The cyclic carbonate and linear carbonate are mixed together in a volume ratio of about 1:1 to about 1:9. When the mixture is utilized as an electrolyte, it may have enhanced performance.

The organic solvent may further include an aromatic hydrocarbon-based solvent as well as the carbonate-based solvent. Herein, the carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

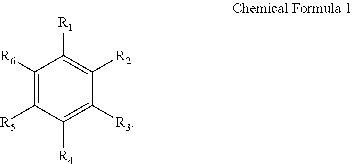

(In Chemical Formula 1, R₁ to R₆ may each independently be the same or different and may include (e.g., are selected from) hydrogen, a halogen, a C1 to C10 alkyl group, a haloalkyl group, and/or a combination thereof.)

Specific examples of the aromatic hydrocarbon-based organic solvent may include (e.g., may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

The electrolyte may further include vinylethyl carbonate, vinylene carbonate, or an ethylene carbonate-based compound represented by Chemical Formula 2, as an additive for improving cycle life.

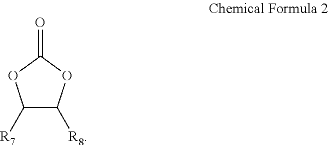

In Chemical Formula 2, R₇ and R₈ may each independently be the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not concurrently (e.g., simultaneously) hydrogen.

Examples of the ethylene carbonate-based compound may include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and/or the like. In case of further utilizing the additive for improving cycle life, an amount of the additive may be suitably controlled or selected within an appropriate or suitable range.

The lithium salt dissolved in an organic solvent supplies a battery with lithium ions, basically operates the rechargeable lithium battery, and improves transportation of the lithium ions between positive and negative electrodes. Examples of the lithium salt may include one or two of (e.g., selected from) LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiCIO₄, LiAlO₂, LiAlCl₄, LiPO₂F₂, LiN(CₓF₂ₓ₊₁SO₂)(C_{y}F_{2y+1}SO₂), where x and y are a natural numbers, for example, an integer of about 1 to about 20, lithium difluoro(bisoxolato) phosphate), LiCl, LiI, LiB(C₂O₄)₂ (lithium bis(oxalato) borate: LiBOB), and/or lithium difluoro(oxalato)borate (LiDFOB), as a supporting electrolytic salt. A concentration of the lithium salt may range from about 0.1 M to about 2.0 M. When the lithium salt is included at the above concentration range, an electrolyte may have excellent or suitable performance and lithium ion mobility due to optimal or suitable electrolyte conductivity and viscosity.

A separator may be disposed between the positive electrode and the negative electrode depending on a type or kind of a rechargeable lithium battery. The separator may utilize polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

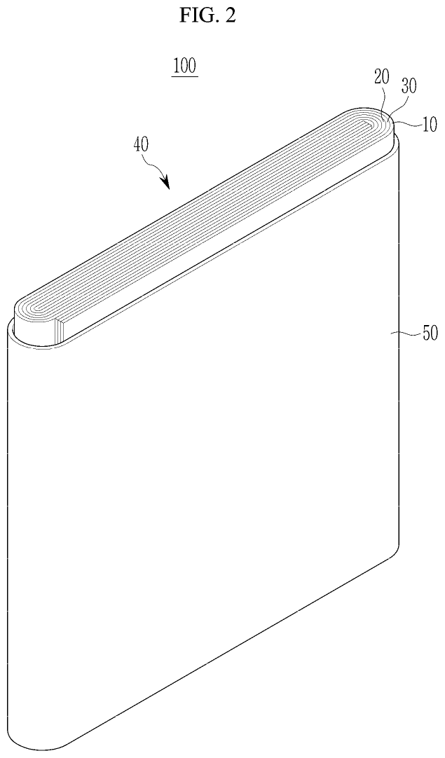

FIG. 2 is an exploded perspective view of a rechargeable lithium battery according to one or more embodiments of the present disclosure. The rechargeable lithium battery according to one or more embodiments is illustrated as a prismatic battery but the present disclosure is not limited thereto and may include variously-shaped batteries such as a cylindrical battery, a pouch battery, and/or the like.

Referring to FIG. 2, a rechargeable lithium battery 100 according to one or more embodiments may include an electrode assembly 40 manufactured by winding a separator 30 disposed between a positive electrode 10 and a negative electrode 20 and a case 50 housing the electrode assembly 40. An electrolyte may be impregnated in the positive electrode 10, the negative electrode 20, and the separator 30.

Hereinafter, examples of the present disclosure and comparative examples are described. These examples, however, are not in any sense to be interpreted as limiting the scope of the present disclosure.

### Example 1

Natural graphite having a particle diameter of greater than or equal to about 80 μm was ground to small-size primary particles having a particle diameter D50 of 7 μm by airstream grinding. The small-size primary particles were processed to secondary particles having an average particle diameter D50 of 15.6 μm utilizing spheroidizing equipment. Pitch carbon was added to the secondary particle and heat-treated in a 1,200° C. sintering furnace for 2 hours to prepare a carbon-based material. Herein, the added amount of the pitch carbon was adjusted in order to have a weight ratio of 90/10 of natural graphite/amorphous carbon of the prepared active material. The prepared active material included natural graphite including secondary particles in which a plurality of primary particles were agglomerated, with soft carbon positioned on the surface of the primary particles, and a soft carbon coating layer around (e.g., surrounding) the secondary particles.

The carbon-based material was utilized as a first active material, and 97.4 wt % of the first active material, 0.9 wt % of carboxymethyl cellulose, and 1.7 wt % of styrene-butadiene rubber were mixed in pure water to prepare a first active material layer slurry.

97.4 wt % of a Si—C composite and a mixture of the prepared carbon-based material and artificial graphite (Si—C composite:(the prepared carbon-based material and artificial graphite)=1:4 by weight ratio, a mixing ratio of the prepared carbon-based material:artificial graphite=1:1 by weight ratio) as a second active material, 0.9 wt % of carboxymethyl cellulose, and 1.7 wt % of styrene-butadiene rubber were mixed in pure water to prepare a second active material layer slurry. Herein, The Si—C composite included a core including artificial graphite and silicon particles and a soft carbon coated on the surface of the core. The soft carbon coating layer had a thickness of 20 nm, and the silicon particles had an average particle diameter D50 of 100 nm.

97 wt % of an artificial graphite third active material, 1 wt % of ketjen black, 1 wt % of carboxymethyl cellulose, and 1 wt % of styrene-butadiene rubber were mixed in pure water to prepare a third active material layer slurry.

The first active material slurry, the second active material slurry, and the third active material slurry were sequentially coated on the Cu foil current collector, dried, and pressurized to prepare a negative electrode including a negative active material layer including a first active material layer, a second active material layer, and a third active material layer. Herein, a thickness ratio of the first active material layer, the second active material layer, and the third active material layer was adjusted until it was to 1:1:1.

In the prepared negative electrode, the amount of silicon was 4.2 wt % based on the total, 100 wt % of the negative active material layer.

Using the negative electrode, a polyethylene/polypropylene separator, a LiCoO₂ positive electrode, and an electrolyte, a cell having a capacity of 36 mAh (model: SLPC) was fabricated.

As the electrolyte, 1.5 M LiPF₆ dissolved ethylene carbonate, ethylmethyl carbonate and dimethyl carbonate (20:10:70 volume ratio), was utilized.

### Example 2

A negative electrode was prepared by substantially the same procedure as in Example 1, except that coating amounts of the first active material layer slurry, the second active material layer slurry, and the third active material layer slurry were changed to prepare a negative active material layer until the thickness ratio of the first active material layer, the second active material layer, and the third active material layer was 1:1.5:1.

In the prepared negative electrode, the amount of silicon was 4.2 wt % based on the total, 100 wt % of the negative active material layer.

Using the negative electrode, a cell was fabricated by substantially the same procedure as in Example 1.

### Comparative Example 1

The first active material slurry, the third active material slurry, and the second active material slurry were sequentially coated on the Cu foil current collector, and dried and pressurized to prepare a negative electrode including a negative active material layer including a first active material layer, a third active material layer, and a second active material layer. Herein, the thickness ratio of the first active material layer, the third active material layer, and the second active material layer was adjusted until it was to 1:1:1. For example, in the prepared negative electrode, the second active material layer including the Si—C was positioned on the outmost surface. In the prepared negative electrode, the amount of silicon was 4.2 wt % based on the total, 100 wt % of the negative active material layer.

Using the negative electrode, a cell was fabricated by substantially the same procedure as in Example 1.

### Comparative Example 2

The second active material slurry, the first active material slurry, and the third active material slurry were sequentially coated on the Cu foil current collector, dried, and pressurized to prepare a negative electrode including a negative active material layer including a second active material layer, a first active material layer, and a third active material layer. Herein, a thickness ratio of the second active material layer, the first active material layer, and the third active material layer was adjusted until it was 1:1:1. For example, in the prepared negative electrode, the second active material layer including the Si—C was positioned in contact with the current collector. In the prepared negative electrode, the amount of silicon was 4.2 wt % based on the total, 100 wt % of the negative active material layer.

Using the negative electrode, a cell was fabricated by substantially the same procedure as in Example 1.

### Experimental Example 1) Evaluation of Cycle-Life Characteristics at Room Temperature

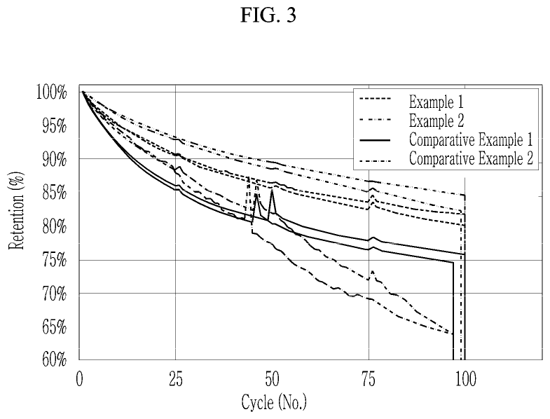

The cells according to Examples 1 and 2 and Comparative Examples 1 and 2 were charged at 0.5 C and discharged at 0.5 C under room temperature (25° C.) for 100 cycles. A ratio (%) of discharge capacity at the 100th to discharge capacity at the 1^{st} was measured. The results are shown in FIG. 3.

A ratio of charge capacity at each cycle to charge capacity at the 1^{st} was measured. The results are shown in FIG. 3. The results shown in FIG. 3 were are obtained from the two cells in each of the examples and the comparative examples, and thus, there are two results for each of the examples and the comparative examples.

As shown in FIG. 3, the half-cell of Example 1 exhibited capacity retention of about 83%, even though the charge and the discharge were performed for about 100 cycles, but Comparative Example 1 exhibited capacity retention of about 79% at about 75 charge and discharge cycles, and Comparative Example 2 exhibited very low capacity retention of about 73%.

### Experimental Example 2) Evaluation of High-Rate Characteristic

The cells of Examples 1 and 2 and Comparative Examples 1 and 2 were charged and discharged for 3 cycles in which they were charged under a condition of a constant current/constant voltage, 0.1 C, 4.3 V and 0.05 C cut-off, rested for 10 minutes, discharged under a condition of a constant current, 0.2 C, 2.8 V cut-off constant current/constant voltage, and rested for 10 minutes. Thereafter, while the C-rate of the discharge condition was changed at 0.5 C, 1.0 C, 1.5 C, 2 C, 2.5 C, and 0.2 C, charging and discharging at each C-rate were performed for 3 cycles.

A ratio of discharge capacity at each cycle to discharge capacity at the 1^{st} at each C-rate were measured. The results are shown in Table 1.

TABLE 1

| | 0.2 C | 0.5 C | 1.0 C | 1.5 C | 2.0 C | 2.5 C | 0.2 C |
|---|---|---|---|---|---|---|---|
| Example 1 | 100% | 94% | 83% | 55% | 37% | 27% | 90% |
| Example 2 | 100% | 96% | 85% | 56% | 37% | 27% | 93% |
| Comparative | 100% | 91% | 83% | 56% | 34% | 22% | 82% |
| Example 1 | | | | | | | |
| Comparative | 100% | 92% | 80% | 55% | 37% | 26% | 88% |
| Example 2 | | | | | | | |

As shown in Table 1, the cells according to Examples 1 and 2 exhibited superior capacity retention at all C-rates, particularly at high rates, than Comparative Examples 1 and 2, and superior capacity retention at the last 0.2 C which indicated better capacity recovery.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present disclosure, and should not be interpreted in an idealized or overly formal sense, unless expressly so defined herein.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” another element or layer, it can be directly on the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The use of “may” when describing embodiments of the present disclosure refers to “one or more embodiments of the present disclosure.”

As used herein, the term “substantially,” “about,” and similar terms are used as terms of approximation and not as terms of degree, and are intended to account for the inherent deviations in measured or calculated values that would be recognized by those of ordinary skill in the art. “About”, “substantially,” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this disclosure is intended to include all higher numerical limitations subsumed therein. Accordingly, Applicant reserves the right to amend this disclosure, including the claims, to expressly recite any sub-range subsumed within the ranges expressly recited herein.

As used herein, the singular forms “a”, “an” and “the” are intended to include the plural forms as well, unless the context clearly indicates otherwise.

It will be further understood that the terms “comprises,” “comprising,” “includes,” and “including,” when used in this disclosure, specify the presence of the stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items.

Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While this disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

What is claimed is:

1. A negative electrode for a rechargeable lithium battery, the negative electrode comprising:
a current collector; and
a negative active material layer comprising a first active material layer, a second active material layer, and a third active material layer,
wherein the first active material layer contacts the current collector and the second active material layer is between the first active material layer and the third active material layer,
wherein the first active material layer comprises a first active material comprising a first crystalline carbon, the second active material layer comprises a second active material comprising a silicon-based active material, a second crystalline carbon, and a third crystalline carbon, and the third active material layer comprises a third active material comprising a fourth crystalline carbon.

2. The negative electrode of claim 1, wherein an amount of silicon in the negative active material layer is about 0.6 wt % to about 9 wt % based on a total, 100 wt % of the negative active material layer.

3. The negative electrode of claim 1, wherein a thickness ratio of the first active material layer, the second active material layer, and the third active material layer is about 1:1 to 49:1 to 49.

4. The negative electrode of claim 1, wherein a thickness ratio of the first active material layer, the second active material layer, and the third active material layer is about 1:1 to 1.5:1 to 1.5.

5. The negative electrode of claim 1, wherein the first crystalline carbon and/or the second crystalline carbon comprises a natural graphite comprising a plurality of secondary particles, each of the plurality of secondary particles comprising a plurality of primary particles that are agglomerated, amorphous carbon on a surface of the plurality of primary particles, and a coating layer comprising amorphous carbon around each of the plurality of secondary particles.

6. The negative electrode of claim 5,
wherein the plurality of primary particles has an average particle diameter of about 5 μm to about 15 μm and the plurality of secondary particles have an average particle diameter of about 8 μm to about 24 μm, and
wherein a peak intensity ratio I(002)/I(110) is about 120 or less, when measured by XRD.

7. The negative electrode of claim 1, wherein a mixing ratio of the second crystalline carbon and the third crystalline carbon is about 1:1 to about 1:9 by weight ratio.

8. The negative electrode of claim 1, wherein the third crystalline carbon is artificial graphite.

9. The negative electrode of claim 1, wherein the fourth crystalline carbon is artificial graphite, natural graphite, or a combination thereof.

10. The negative electrode of claim 1, wherein each of the first crystalline carbon and the second crystalline carbon comprises a natural graphite comprising a plurality of secondary particles, each of the plurality of secondary particles comprising a plurality of primary particles that are agglomerated, amorphous carbon on a surface of the plurality of primary particles, and a coating layer comprising amorphous carbon around each of the plurality of secondary particles, wherein the third crystalline carbon is artificial graphite, and wherein the fourth crystalline carbon is artificial graphite, natural graphite, or a combination thereof.

11. A rechargeable lithium battery, comprising:
the negative electrode of claim 1;
a positive electrode; and
an electrolyte.

12. A method of manufacturing a negative electrode for a rechargeable lithium battery,
the negative electrode comprising a current collector and a negative active material layer comprising a first active material layer of a first active material, a second active material layer of a second active material, and a third active material layer of a third active material,
the method comprising:
applying the current collector;
applying the first active material as the first active material layer to contact the current collector, the first active material comprising a first crystalline carbon;
applying the second active material as the second active material layer, the second active material comprising a silicon-based active material, a second crystalline carbon, and a third crystalline carbon; and
applying the third active material as the third active material layer such that the second active material layer is between the first active material layer and the third active material layer, the third active material comprising a fourth crystalline carbon.
